(19) United States
(12) Patent Application Publication
(10) Pub. No.: US 2024/0214851 A1
(43) Pub. Date: Jun. 27, 2024

(54) TRIGGERING OF A REPORT

(71) Applicant: Samsung Electronics Co., Ltd., Suwon-si (KR)

(72) Inventors: Md. Saifur Rahman, Plano, TX (US); Dalin Zhu, Allen, TX (US); Emad Nader Farag, Flanders, NJ (US); Gilwon Lee, McKinney, TX (US); Eko Onggosanusi, Coppell, TX (US)

(21) Appl. No.: 18/536,025

(22) Filed: Dec. 11, 2023

Related U.S. Application Data
(60) Provisional application No. 63/434,767, filed on Dec. 22, 2022.

(51) Int. Cl. H04W 24/10

(52) U.S. Cl. CPC H04W 24/10; H04B 7/06952

(57) ABSTRACT

Methods and apparatuses for triggering a report. A method for operating a user equipment (UE) includes transmitting information including at least one of (i) a trigger indicating a need for transmitting a report and (ii) content associated with the report. The trigger is related to a channel between the UE and a network entity. The need is based on at least one performance metric of a communication over the channel. The content includes at least one property associated with the channel.

### CROSS-REFERENCE TO RELATED AND CLAIM OF PRIORITY

The present application claims priority under 35 U.S.C. § 119(e) to U.S. Provisional Patent Application No. 63/434,767 filed on Dec. 22, 2022, which is hereby incorporated by reference in its entirety.

### TECHNICAL FIELD

The present disclosure relates generally to wireless communication systems and, more specifically, the present disclosure relates to methods and apparatuses for triggering of a report.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to triggering of a report.

In one embodiment, a user equipment (UE) is provided. The UE includes a processor and a transceiver operably coupled to the processor. The transceiver is configured to transmit information including at least one of (i) a trigger indicating a need for transmitting a report and (ii) content associated with the report. The trigger is related to a channel between the UE and a network entity. The need is based on at least one performance metric of a communication over the channel. The content includes at least one property associated with the channel.

In another embodiment, a base station (BS) is provided. The BS includes a processor and a transceiver operably coupled to the processor. The transceiver is configured to receive information including at least one of (i) a trigger indicating a need for transmitting a report and (ii) content associated with the report. The trigger is related to a channel between a UE and the BS. The need is based on at least one performance metric of a communication over the channel. The content includes at least one property associated with the channel.

In yet another embodiment, a method for operating a UE is provided. The method includes transmitting information including at least one of (i) a trigger indicating a need for transmitting a report and (ii) content associated with the report. The trigger is related to a channel between the UE and a network entity. The need is based on at least one performance metric of a communication over the channel. The content includes at least one property associated with the channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a flowchart of an example UE procedure for reporting aperiodic content/quantity according to embodiments of the present disclosure;

FIGS. 8A-8C illustrate flowcharts for example UE-initiated reporting methods according to embodiments of the present disclosure;

FIGS. 9A-9C illustrate flowcharts for additional example UE-initiated reporting methods according to embodiments of the present disclosure.

### DETAILED DESCRIPTION

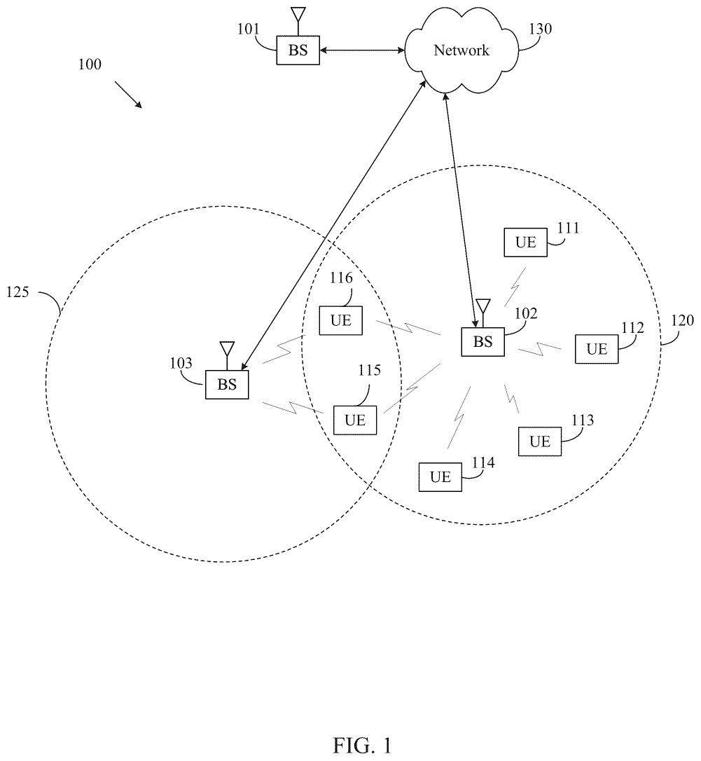

FIGS. 1-9C, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: c

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for triggering a report. In certain embodiments, one or more of the BSs 101-103 include circuitry, programing, or a combination thereof to support UE triggered reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

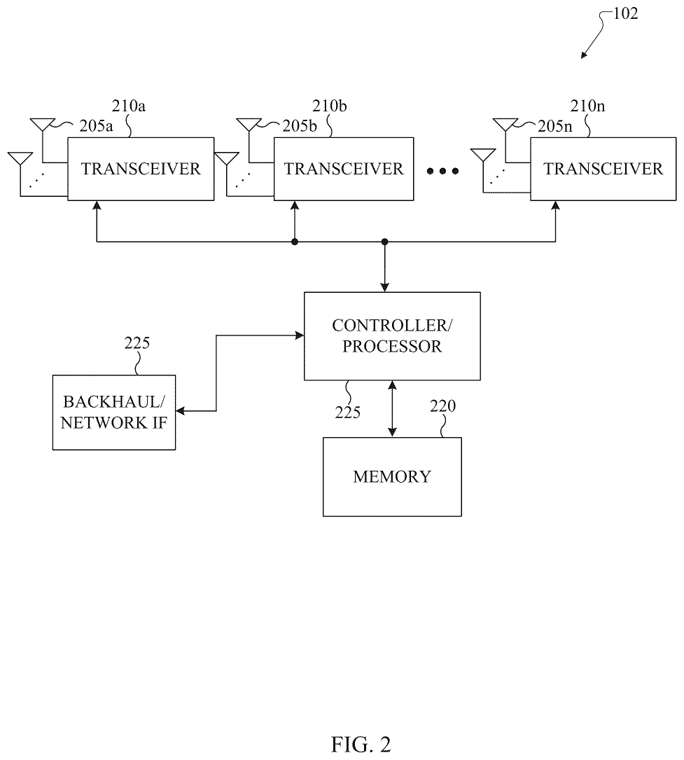

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UE triggered reporting. Any of a wide variety of other functions could be supported in the gNB 102 by the controller/processor 225.

The controller/processor 225 is also capable of executing programs and other processes resident in the memory 230, such as support for UE triggered reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

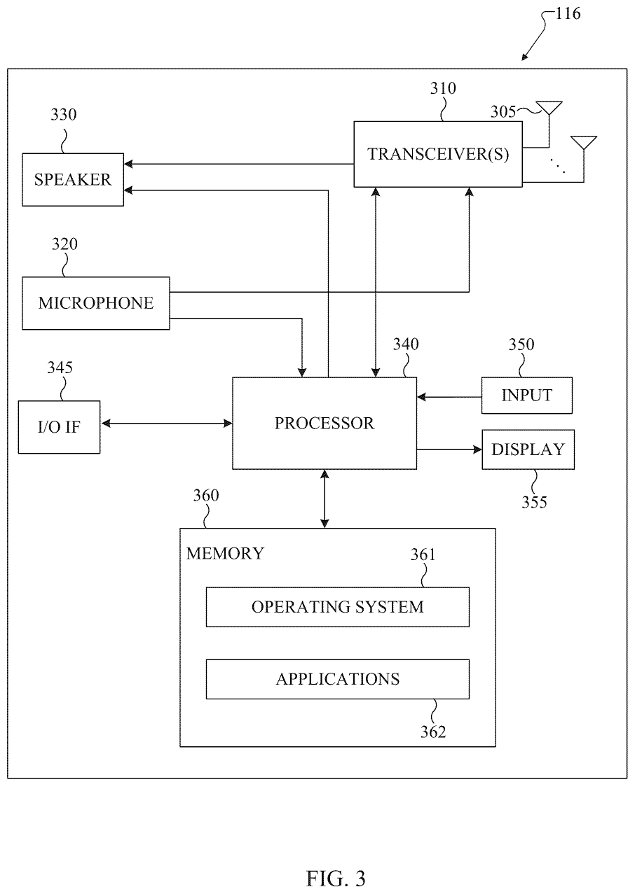

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for triggering a report as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

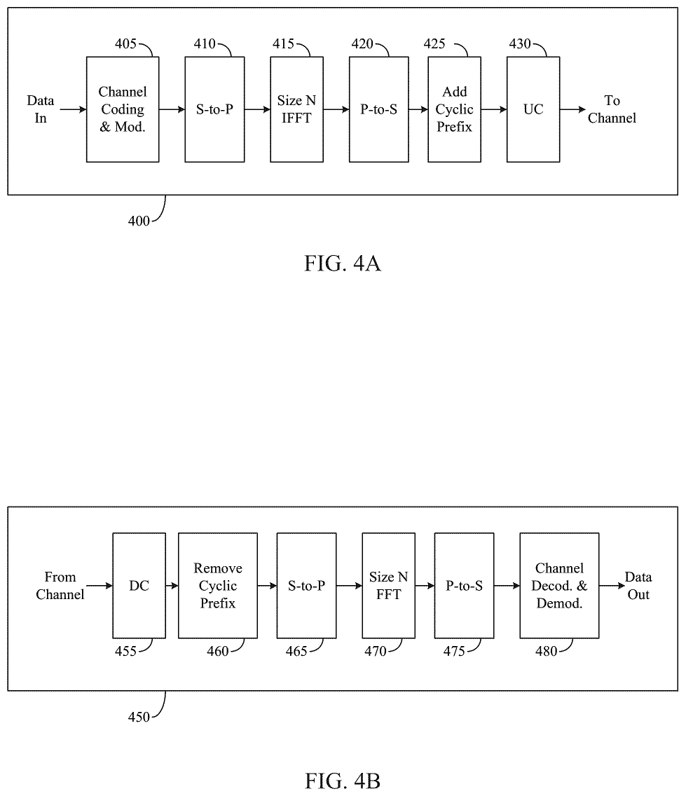

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to support triggering a report as described in embodiments of the present disclosure.

As illustrated in FIG. 4A the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

As illustrated in FIG. 4B, in the transmit path 400 the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

A transmitted RF signal from the gNB 102 arrives at the UE 116 after passing through the wireless channel, and reverse operations to those at the gNB 102 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

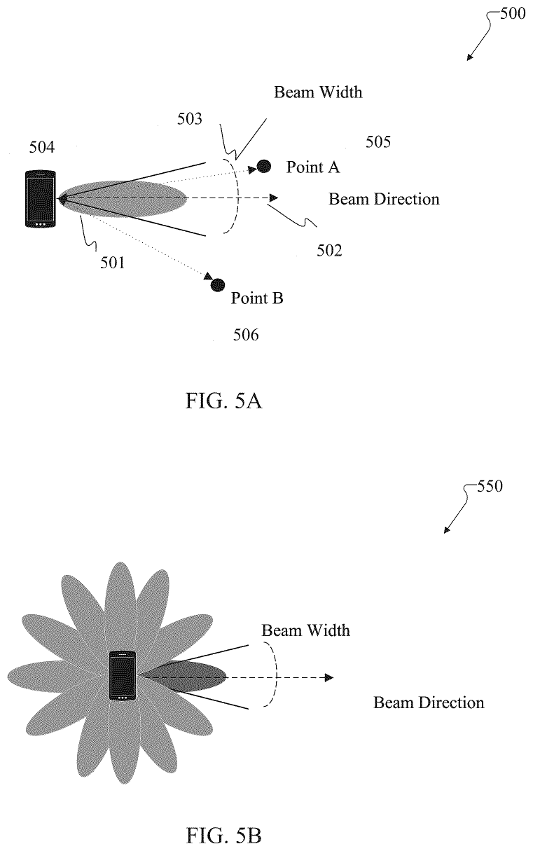

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

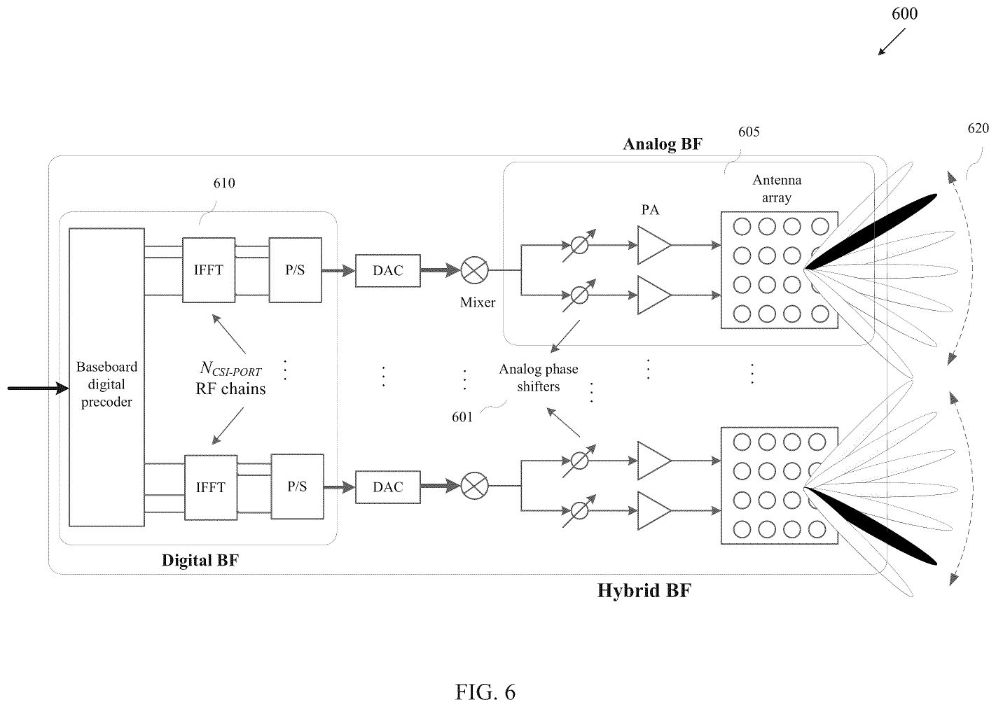

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

In this disclosure, a beam is determined by either of:
A TCI state, that establishes a quasi-colocation (QCL) relationship between a source reference signal (e.g., SSB and/or CSI-RS) and a target reference signal.
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, multi-beam operation is designed primarily in a per TRP (transmit-receive point or per antenna panel manner. Therefore, the specification supports beam indication for one TX beam wherein a TX beam is associated with a source RS. For DL beam indication and measurement, the source RS can be NZP (non-zero power) CSI-RS and/or SSB (synchronization signal block, which includes primary synchronization signal, secondary synchronization signal, and physical broadcast channel (PBCH)). Here, DL beam indication is done via the transmission configuration indicator (TCI) field in DL-related downlink control information (DCI) which includes an index to one (and only one) assigned source RS. A set of hypotheses, or the so-called TCI states, is configured via higher-layer (RRC) signaling and, when applicable, a subset of those TCI states is selected/activated via MAC CE for the TCI field code points. For UL beam indication and measurement, the source RS can be NZP CSI-RS, SSB, and/or SRS. In Rel.15/16, UL beam indication is done via the SRS resource indicator (SRI) field in UL-related DCI which is linked to one (and only one) reference RS. This linkage is configured via higher-layer signaling using the SpatialRelationInfo RRC parameter. Essentially, only one TX beam is indicated to the UE. In Rel.17, a unified TCI state indication is supported wherein DL or/and UL beam indication and measurement is done via the TCI state code points in the DL-DCI (same as in Rel.15 TCI state indication). The code points can indicate one TCI state (for DL, UL, or both DL/UL) or a pair of TCI states (for DL and UL).

In (up to Rel.17) NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.). For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB. Such UE-initiated reporting for a content can be enabled for other types of report quantities (different from traditional beam or CSI reports).

Embodiments of the present disclosure recognize, although UE-initiated reporting can be beneficial, efficient designs are needed to ensure that the latency is reduced and, at the same time, error events can be minimized. Therefore, there is a need for efficient designs for UE-initiated reporting for a content that can offer good trade-off between latency and reliability. In particular, when the UE-initiated reporting framework can include multiple report types (or report quantities), or/and multiple event types when a report types can be associated with an event (e.g., for beam report, the event can be beam failure, and for CSI, the event can be user throughput degradation or increasing retransmission rate).

This disclosure provides example embodiments on the above mentioned UE-initiated reporting for different types of reporting contents.

The present disclosure relates to UE-initiated request/reporting of a content in a communication system. Various embodiments include the following:
UE-initiated reporting framework for multiple report-types (quantities) or/and event-types.
NW-configuring/controlling the event-type or/and report-type, but UE-initiating/triggering the report.
UE-initiating only a request (NW may or may not configure reporting).

Aspects, features, and advantages of the present disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

In the following, for brevity, both frequency division duplexing (FDD) and time division duplexing (TDD) are regarded as the duplex method for both DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction, in combination with one another, or can operate as standalone schemes.

In the present disclosure, the term “activation” describes an operation wherein a UE receives and decodes a signal from the network (or gNB) that signifies a starting point in time. The starting point can be a present or a future slot/subframe or symbol—the exact location either implicitly or explicitly indicated, or otherwise fixed or higher-layer configured. Upon successfully decoding the signal, the UE responds accordingly. The term “deactivation” describes an operation wherein a UE receives and decodes a signal from the network (or gNB) that signifies a stopping point in time. The stopping point can be a present or a future slot/subframe or symbol—the exact location either implicitly or explicitly indicated, or otherwise fixed or higher-layer configured. Upon successfully decoding the signal, the UE responds accordingly.

Terminology such as TCI, TCI states, SpatialRelationInfo, target RS, reference RS, and other terms is used for illustrative purposes and therefore not normative. Other terms that refer to the same functions can also be used.

A “source RS” corresponds to a set of characteristics of DL or UL TX beam, such as direction, precoding/beamforming, number of ports, etc. For instance, as the UE receives a source RS index/ID in a DL assigned represented by a TCI state, the UE applies the known characteristics of the source RS to the assigned DL transmission (or/and UL transmission). The source RS can be received and measured by the UE (in this case, the source RS is a downlink measurement signal such as NZP CSI-RS and/or SSB) with the result of the measurement used for calculating a beam report (at least one L1-receive signal received power (RSRP)/L1-signal to interference and noise ratio (SINR) accompanied by at least one CRI or symbol based subband reuse indicator (SSBRI)). As the NW/gNB receives the beam report, the NW can be better equipped with information to assign a particular DL (or/and UL) TX beam to the UE. Optionally, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE. This option is applicable when DL-UL beam pair correspondence holds.

The transmission/measurement of the source RS can be dynamically triggered by the NW/gNB (e.g., via DCI in case of aperiodic RS), preconfigured with a certain time-domain behavior (such as periodicity and offset, in case of periodic RS), or a combination of such pre-configuration and activation/deactivation (in case of semi-persistent RS).

There are two types of frequency range (FR) defined in 3GPP NR specifications. The sub-6 GHz range is called frequency range 1 (FR1) and millimeter wave range is called frequency range 2 (FR2). An example of the frequency range for FR1 and FR2 is shown herein.

| Frequency range designation | Corresponding frequency range |
|---|---|
| FR1 | 450 MHz-6000 MHz |
| FR2 | 24250 MHz-52600 MHz |

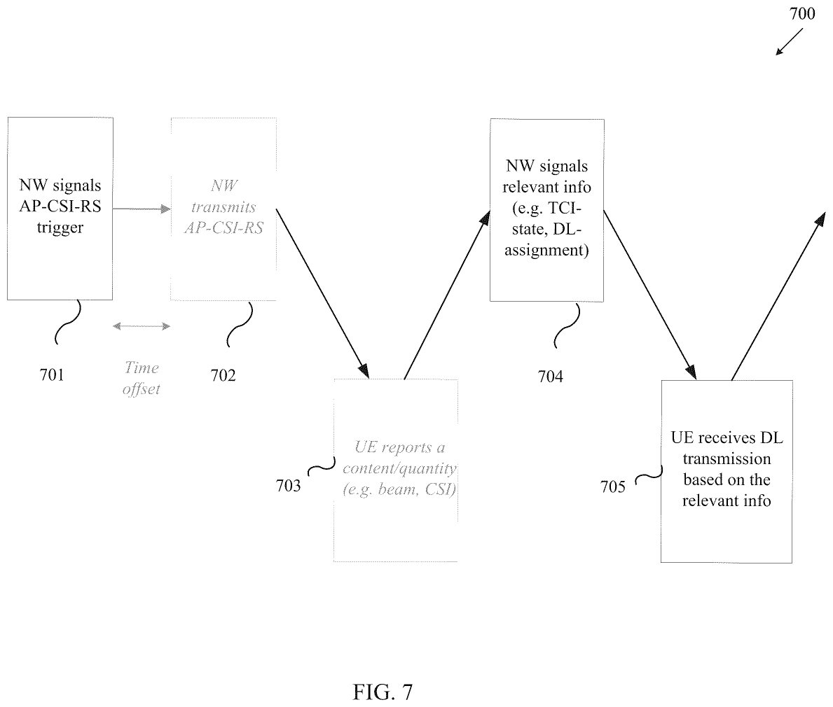

FIG. 7 illustrates a flowchart of an example UE procedure 700 for reporting aperiodic content/quantity according to embodiments of the present disclosure. For example, procedure 700 for reporting aperiodic content/quantity can be performed by any of the UEs 111-116 of FIG. 1 and a complimentary process may be performed by the NW 130 and/or BS 102 of FIG. 1. This example is for illustration only and other embodiments can be used without departing from the scope of the present disclosure.

The procedure begins in 701, the gNB 102/NW 130 signals to a UE an aperiodic CSI-RS (AP-CSI-RS) trigger or indication. This trigger or indication can be included in a DCI (either UL-related or DL-related, either separately or jointly signaled with an aperiodic CSI request/trigger) and indicate transmission of AP-CSI-RS in a same (zero time offset) or later slot/sub-frame (>0 time offset). In 702, upon receiving the AP-CSI-RS transmitted by the gNB 102/NW 130, the UE 116 measures the AP-CSI-RS and, in turn, in 703, calculates and reports the content/quantity. For instance, when content=beam, a “beam metric” indicating quality of a particular TX beam hypothesis is included in the report, and likewise, when content=CSI, precoding matrix indicator (PMI)/channel quality indicator (CQI)/Rank indicator (RI) (may also include LI/CRI)) indicating DL channel state information is included in the report. For beam, examples of such beam reporting (supported in Rel.15/16 NR) are CSI-RS resource indicator (CRI) or SSB resource indicator (SSB-RI) coupled with its associated L1-RSRP and/or L1-SINR. In 704, upon receiving the report from the UE 116, the NW 130/gNB 102 can use the report to select/indicate relevant information about an upcoming DL (or UL) transmission. The relevant information can include a DL TX beam for the UE 116 (e.g. using the TCI field in the DL-related DCI that carries the DL assignment, such as DCI format 1_1 in NR) or/and DL assignment. In 705, upon successfully decoding the DL-related DCI, the UE 116 performs DL reception (such as data transmission on physical downlink shared channel (PDSCH)) based on the relevant information provided to the UE 116. The aperiodic CSI-RS (along with the associated aperiodic reporting) in the procedure can be substituted with that of another time-domain behavior such as semi-persistent (SP) or periodic (P).

The following embodiment is an example of DL multi-beam operation that utilizes DL beam indication after the network (NW) 130 receives some transmission from the UE 116. In the first example embodiment, aperiodic CSI-RS is transmitted by the NW 130 and measured by the UE 116. Although aperiodic RS is used in these two examples, periodic or semi-persistent RS can also be used.

For mmWave (or FR2) or higher frequency bands (such as >52.6 GHz or FR4) where multi-beam operation is especially relevant, transmission-reception process includes the receiver to select a receive (RX) beam for a given TX beam. For DL multi-beam operation, the UE 116 selects a DL RX beam for each DL TX beam (which corresponds to a source RS, represented by a TCI state). Therefore, the NW 130/gNB 102 triggers or configures the UE 116 to receive a DL RS (which is associated with a selection of DL TX beam). The UE 116, upon receiving and measuring the DL RS, calculates a beam report and transmits it to the gNB/NW, which in turn selects a DL TX beam. As a result, a TX-RX beam pair is derived. The NW 130/gNB 102 can perform this operation for each of the configured source RSs or TCI states (either per reference RS or “beam sweeping”) and determine each of the TX-RX beam pairs associated with each of the source RSs (TCI states) configured to the UE 116.

In the present disclosure, the term “Resource Indicator”, also abbreviated as REI, is used to refer to an indicator of RS resource used for signal/channel and./or interference measurement. This term is used for illustrative purposes and hence can be substituted with any other term that refers to the same function. Examples of REI include the aforementioned CSI-RS resource indicator (CRI) and SSB resource indicator (SSB-RI). Any other RS can also be used for signal/channel and/or interference measurement such as demodulation reference signal (DMRS).

In any of the embodiments or sub-embodiments or examples herein, a flowchart is used for illustrative purposes. The present disclosure covers any possible variation of the flowchart as long as at least some of the components are included.

In the rest of the disclosure, the term “beam”, can be associated with a spatial transmission/reception of a resource signal (RS) from a “port”, “antenna port”, or “virtual antenna/port”. Likewise, the term “transmit (TX) beam”, can be associated with a spatial transmission of a resource signal (RS) or a channel from a “port”, “antenna port”, or “virtual antenna/port”; and the term “receive (RX) beam”, can be associated with a spatial reception of a resource signal (RS) or a channel from a “port”, “antenna port”, or “virtual antenna/port”. The spatial transmission/reception of a beam can be in a three-dimension (3D) space. In a beam-formed wireless system, the transmission and reception of wireless signal can be via multiple TX and multiple RX beams.

The present disclosure includes the following components: (1) UE-initiated/triggered report including one of or both of a trigger/message and a content (report quantities), based on an event, where the event and the report can be multiple types (multiple event-types and multiple report-types), (2) configuration from the NW, and (3) one-part of two-part reporting of the content.

In one embodiment, a UE detects (or determines) a need for transmitting a UE-initiated/UE-triggered report (or initiation/triggering) of a (report-) type (A), (B), or (C), where
(A) includes an initiator/trigger/pre-notification message;
(B) includes a report/content (comprising one or multiple report quantities); and/or
(C) includes both a trigger/pre-notification message and a (corresponding) report/content

The report is to facilitate/enable efficient/timely/fast/reliable communication over the link/channel between a target entity (e.g., NW/gNB or another device) and the UE 116, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is a beam (source RS) indicator (e.g., CRI, SSBRI) and Jᵢ is abeam metric (e.g., L1-RSRP, L1-SINR).
In one example, the content includes CSI-related quantity/quantities. For example, at least one of (RI, PMI, CQI, CRI, LI).
In one example, the content includes transport block coding process (TDCP)-related quantity/quantities. For example, an indicator about the Doppler profile (e.g., Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
      beam (TCI state) TCI states (e.g., DL TCI state, UL TCI state, or unified (joint) DL/UL TCI state);
      panel(s) (e.g., UE panels for DL reception or/and UL transmission);
      antenna(e) (e.g., UE antennae for DL reception or/and UL transmission); or
      antenna port(s) (e.g., UE antenna ports for DL reception or/and UL transmission).
   In one example, quantity/quantities comprise an indicator indicating switching from one beam to another beam, or from one panel to another, or from one antenna port group to another antenna port group, or from N₁ SRS ports to N₂ SRS ports, where N₁≠N₂ (e.g., this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE 116 is a Uu interface (i.e., DL, UL).

In one example, the link/channel between the target entity and the UE 116 is a sidelink (SL), or a device-to-device (D2D) or PC5 interface.

In one example, such reporting can be non-event-based or autonomous. The UE 116 can initiate/trigger the report autonomously (i.e., without being associated with any event) or unconditionally/freely. For example, the UE 116 can be configured with a triggering time window (or multiple UL slots), and the UE 116 can trigger the report during this window.

In one example, such reporting can be event-based, i.e., the UE 116 can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE 116-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous U-initiated report are shown in Table 5.

TABLE 1

| | Report | | |
|---|---|---|---|
| Event type | Type | Trigger/pre-notification message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other | (A) | Yes (no need for content) | No |
| (content-free/ | | | |
| less events) | | | |

TABLE 2

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3

| Report-type | Trigger/pre-notification message | Content |
|---|---|---|
| (A) | Yes | No |
| (B) | No | Yes |
| (C) | Yes | Yes |

TABLE 4
Report

| Type | Trigger/pre-notification message | Content |
|---|---|---|
| 0 | Yes (e.g., beam-related event), content-specific | No |
| | or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, an index or a parameter (e.g., reportQuantity) can be used to indicate one example from tables herein. The index/parameter can be used to configure the UE 116-initiated report according to one or more examples described herein, e.g., via higher layer RRC. Such a configuration can be subject to the UE 116 capability. In one example, the index/parameter can also indicate multiple (e.g., 2) examples from the table herein. In this case, the UE 116-initiated report can include the report for at least one for the two (more details are provided herein).

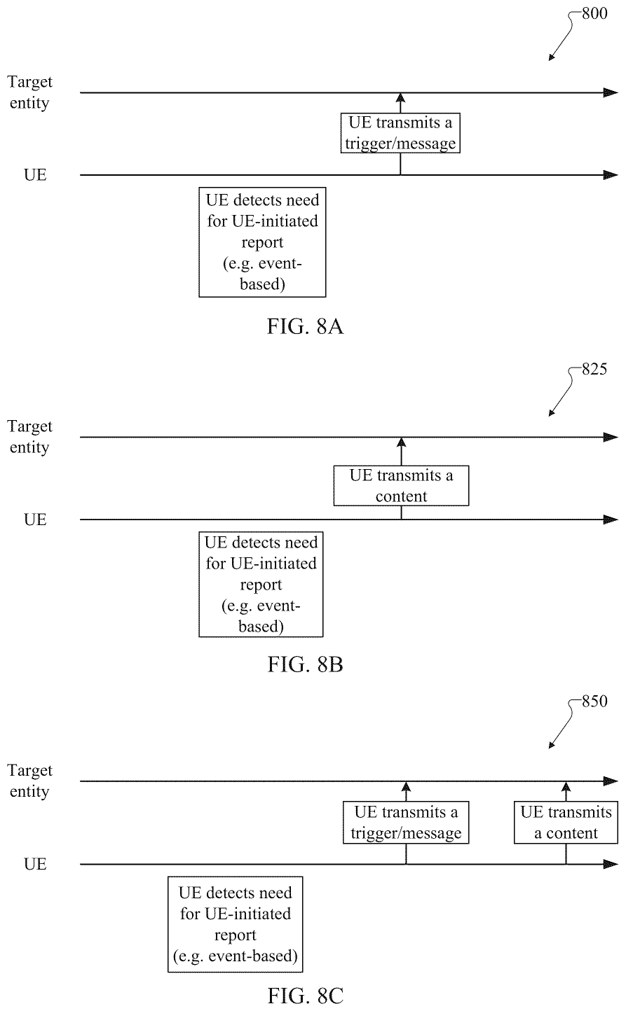

FIGS. 8A-8C illustrate flowcharts for example UE-initiated reporting methods 800-850 according to embodiments of the present disclosure. For example, the methods 800-850 can be performed by any of the UEs 111-116 in connection with a target entity, which could be over an uplink channel with an eNB (e.g., BS 102) or a network entity (e.g., NW 130) or over a sidelink channel another UE (e.g., another of UEs 111-116). This example is for illustration only and other embodiments can be used without departing from the scope of the present disclosure.

In one example, the UE 116 can be configured with the UE 116-initiated report (e.g., via RRC), and only then the UE 116, on detecting a need, can trigger/initiate the report, and transmit a trigger/message, e.g., a report request via scheduling request (SR), or uplink control information (UCI), or random access channel (RACH) message. The UE 116 can also transmit the report content via UL resource/channel (configured or granted) for the report. The UL resource/channel can be granted to the UE 116 via DCI or/and medium access control (MAC)-control element (CE).

The configuration can provide some information about the UE 116-initiated report.
In one example, the information includes an event-type (e.g., type0=beam).
In one example, the information includes a report-type.
In one example, the information includes (event-type, report-type).
In one example, the information includes content (each or a subset) or report quantity/quantities.
In one example, the information includes an event-type and content (each or a subset) or report quantity/quantities.
In one example, the information includes a report-type and content (each or a subset) or report quantity/quantities.
In one example, the information includes an event-type, a report-type and content (each or a subset) or report quantity/quantities.
In one example, the information includes an event-type (e.g., type0=beam) and the corresponding event (details provided herein).
In one example, the information includes a report-type and the corresponding event (details provided herein).
In one example, the information includes (event-type, report-type) and the corresponding event (details provided herein).
In one example, the information includes content (each or a subset) or report quantity/quantities and the corresponding event (details provided herein).
In one example, the information includes an event-type and content (each or a subset) or report quantity/quantities and the corresponding event (details provided herein).
In one example, the information includes a report-type and content (each or a subset) or report quantity/quantities and the corresponding event (details provided herein).
In one example, the information includes an event-type, a report-type, and content (each or a subset) or report quantity/quantities, and the corresponding event (details provided herein).

All of the examples described herein, in which the information includes an event-type, can be extended to the case when the information includes multiple event-types. The report-types of these event-types can be restricted to be the same (e.g., each are type (B)). Or the report-types of these event-types can be independent (same/different) for each event-type.
In one example, the UE 116 can select/report the UE 116-initiated report for one of the multiple event-types, where the selection can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected event-type.
In one example, the UE 116 transmits the report for n event-types(s), where 1≤n≤N and N=number of configured event-types. The n selected event-types can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected event-types (e.g., a N-bit bitmap) and UCI part 2 include the report of the selected event-types.
In one example, the UE 116 transmits the report for each configured event-types.

Analogously, one or more examples described herein, in which the information includes a report-type, can be extended to the case when the information includes multiple report-types. The event-types of these report-types can be restricted to be the same (e.g., each are type0=beam) Or the event-types of these report-types can be independent (same/different) for each report-type.
In one example, the UE 116 can select/report the UE 116-initiated report for one of the multiple report-types, where the selection can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected report-type.
In one example, the UE 116 transmits the report for m report-types(s), where 1≤m≤M and M=number of configured report-types. The m selected report-types can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected report-types (e.g., a M-bit bitmap) and UCI part 2 include the report of the selected report-types.
In one example, the UE 116 transmits the report for each configured report-types.

Analogously, one or more examples described herein, in which the information includes a pair (event-type, report-type), can be extended to the case when the information includes multiple pairs (event-type, report-type).
In one example, the UE 116 can select/report the UE 116-initiated report for one of the multiple pairs of (event-type, report-type), where the selection can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected pair of (event-type, report-type).
In one example, the UE 116 transmits the report for m pair(s) of (event-type, report-type), where 1≤m≤M and M=number of configured pairs of (event-type, report-type). The m selected pairs of (event-type, report-type) can be fixed (e.g., based on a priority order), or reported by the UE 116 (e.g., via the trigger/message), or based on a signaling (DCI or MAC CE) from the NW 130. When the UE 116 reports the selection via a UCI, the UCI can be a two-part UCI, where UCI part 1 can include the information about the selected pairs of (event-type, report-type) (e.g., a M-bit bitmap) and UCI part 2 include the report of the selected pairs.
In one example, the UE 116 transmits the report for each configured report-types.

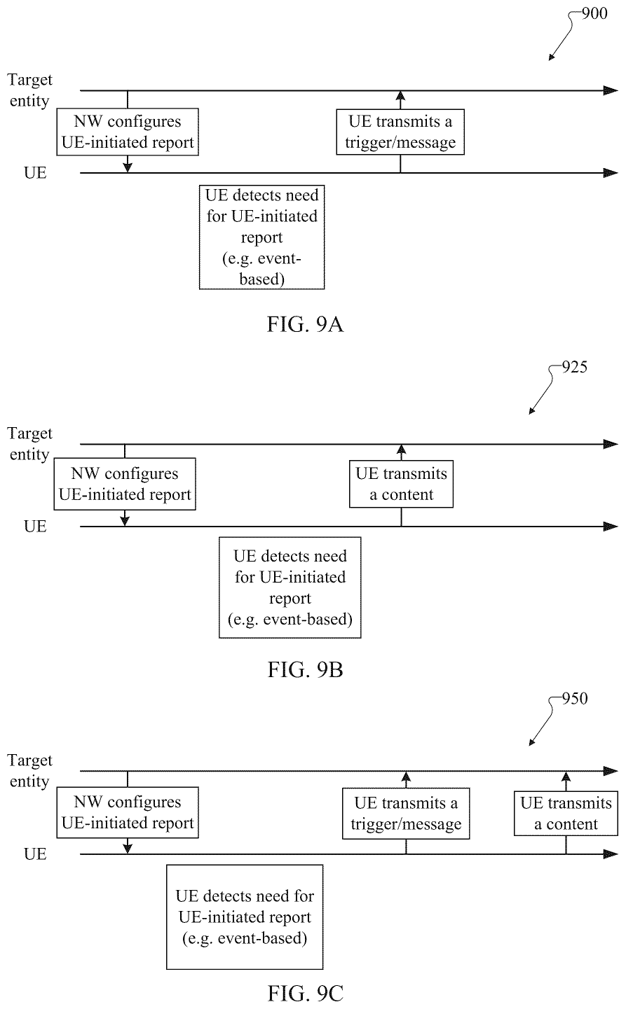

FIGS. 9A-9C illustrate flowcharts for example UE-initiated reporting methods 900-950 according to embodiments of the present disclosure. For example, the methods 900-950 can be performed by any of the UEs 111-116 in connection with a target entity, which could be over an uplink channel with an eNB (e.g., BS 102) or a network entity (e.g., NW 130) or over a sidelink channel another UE (e.g., another of UEs 111-116). This example is for illustration only and other embodiments can be used without departing from the scope of the present disclosure.

In one example, there is no configuration from the NW 130/gNB 102 to the UE 116, and the UE 116, on detecting a need, is free to trigger/initiate the report, and transmit a trigger/message, e.g., a report request via scheduling request (SR), or UCI, or RACH message. The UE 116 can also transmit the report content via UL resource/channel (configured or granted) for the report. The UL resource/channel can be granted to the UE 116 via DCI or/and MAC-CE. Some information about the UE 116-initiated report can also be reported by the UE 116, e.g., via the trigger/message, where the information is according to at least one of the examples described herein.

In one embodiment, for an event-based UE-initiated report, an event can be according to at least one of the following examples:
In one example, for a beam-related event-type, at least one of the examples can be used as an event.
   In one example, the event is related to transmission/decoding failure or block error rate (BLER), e.g., the UE 116 initiates/triggers a beam report when the event is detected, implying the transmission/decoding failure may happen (or BLER may exceed a threshold) with the current beam.
   In one example, the event is related to beam failure, e.g., the UE 116 initiates/triggers a beam report when the event is detected, implying the beam failure may happen with the current beam.
   In one example, the event is related to maximum permissible emission (MPE), the UE 116 initiates/triggers a beam report when the MPE is detected, implying the Tx power can exceed the MPE limit/threshold with the current beam.
   In one example, the event is related to panel/beam switch, the UE 116 initiates/triggers a beam report when the UE 116 detects a need for panel/switch, implying the UE 116 demands to switch from the current panel/beam to another panel(s)/beam.
   In one example, the beam report in one or more examples described herein can correspond to a full report (based on Rel.15-17 reportQuantity, i.e., ‘cri-RSRP’ or ‘ssb-Index-RSRP’ or ‘cri-SINR’, or ‘ssb-Index-SINR’ or ‘cri-RSRP-CapabilityIndex’ or ‘ssb-Index-RSRP-CapabilityIndex’ or ‘cri-SINR-CapabilityIndex’, or ‘ssb-Index-SINR-CapabilityIndex’) or a partial report (e.g. only report without beam metric, i.e., ‘cri’ or ‘ssb-Index’ or ‘cri-CapabilityIndex’ or ‘ssb-Index-CapabilityIndex’).
In one example, for a CSI-related event-type, at least one of the examples can be used as an event.
   In one example, the event is related to transmission/decoding failure or BLER, e.g., the UE 116 initiates/triggers a CSI report when the event is detected, implying the transmission/decoding failure may happen (or BLER may exceed a threshold) with the current transmission or last reported CSI.
   In one example, the event is related to a CSI parameter from (PMI, RI, CQI, CRI, LI). For example, the event is related to CQI, e.g., the UE 116 initiates/triggers a CSI (or CQI) report when the event is detected, implying the transmission/decoding failure may happen (or BLER may exceed a threshold) with the current transmission or last reported CSI (or CQI).
   In one example, for CSI across multiple TRPs (or multiple CSI-RS resources), the event is related to TRP/resource selection/switch (e.g. semi-static transmission resource pool (sTRP)/continuous joint transmission (CJT)/non-continuous joint transmission (NCJT)), e.g. the UE 116 initiates/triggers a CSI report when the event is detected, implying the set of multiple TRPs/resources demands to be updated (otherwise the transmission/decoding failure may happen or BLER may exceed a threshold). The updated set can correspond to adding/removing one or more TRPs from the set and transmitting the updated CSI for the updated set.
   In one example, the CSI report in one or more examples described herein can correspond to a full report (based on Rel.15-17 reportQuantity, i.e., ‘cri-RI-PMI-CQI’, or ‘cri-RI-LI-PMI-CQI’ or ‘cri-RI-i1’ or ‘cri-RI-CQI’ or ‘cri-RI-i1-CQI’) or a partial report (e.g. without RI, i.e., ‘cri-PMI-CQI’, or ‘cri-LI-PMI-CQI’ or ‘cri-i1’ or ‘cri-CQI’ or ‘cri-i1-CQI’).
In one example, for a TDCP-related event-type, at least one of the examples can be used as an event.
   In one example, the event is related to transmission/decoding failure or BLER, e.g., the UE 116 initiates/triggers a TDCP report when the event is detected, implying the transmission/decoding failure may happen (or BLER may exceed a threshold) with the current transmission or last reported TDCP.
   In one example, the event is related to Doppler profile (e.g., which can be measurement via tracking reference signal (TRS) resources), e.g., the UE 116 initiates/triggers a TDCP report when the event is detected, implying that the Doppler spread, or Doppler shift or relative Doppler spread, or relative Doppler shift has exceeded a threshold.
   In one example, the event is related to auto-correlation profile (e.g., which can be measurement via TRS resources), e.g., the UE 116 initiates/triggers a TDCP report when the event is detected, implying that the auto-correlation value (e.g., corresponding to a delay/lag) has exceeded a threshold.
In one example, for a non-CSI/beam/TDCP-related event-type, at least one of the examples can be used as an event.
   In one example, the event is related to beam indication, e.g., the UE 116 initiates/triggers a beam indication (e.g., TCI state indication) when the event is detected, implying that a beam/transmission failure may happen with the current beam.
   In one example, the event is related to beam switch, e.g., the UE 116 initiates/triggers a beam switch when the event is detected, implying that a beam/transmission failure may happen if beam switch does not happen.
   In one example, the event is related to SRS configuration, e.g., the UE 116 initiates/triggers reporting of a number of SRS ports when the event is detected, implying that the UE 116 demands to switch from N1-port SRS to N2-port SRS, where N₁≠N₂.
   In one example, the event is related to an RS, e.g., SRS (AP/SP SRS) or CSI-RS (AP/SP CSI-RS).

In one example, the event can be based on (corresponds to) comparing a metric (M) with a threshold (t).
In one example, if M≤t, the event is detected or declared positive.
In one example, if M<t, the event is detected or declared positive.
In one example, if M≥t, the event is detected or declared positive.
In one example, if M>t, the event is detected or declared positive.
In one example, if M=t, the event is detected or declared positive.

In one example, the event can be based on (corresponds to) comparing a metric (M) with two thresholds (t₁, t₂), e.g., a max value and a min value.
In one example, if t₁≤M≤t₂, the event is detected or declared positive.
In one example, if t₁<M≤t₂, the event is detected or declared positive.
In one example, if t₁≤M≤t₂, the event is detected or declared positive.
In one example, if t₁<M≤t₂, the event is detected or declared positive.

In one example, the event can be based on (corresponds to) comparing a metric (M) with a set of values S.
In one example, if M∈S, the event is detected or declared positive.
In one example, if M∈ S, the event is detected or declared positive.

For beam, the metric can be power, RSRP, or SINR. For CSI, the metric can be UE speed, PDSCH decoding failure (increasing decoding error), or increasing retransmission requests. For TDCP, the metric can be UE speed, or Doppler spread, or auto-correlation value.

Some information about the event can be configured (e.g., via RRC), or reported by the UE 116 (e.g., via trigger/message).

In one embodiment, when there is no content associated with a pre-notification message/trigger, i.e., the report-type is (A), the trigger/pre-notification message simply provides a ‘hint/alarm/cue’ to the target entity according to at least one of the examples described herein.

In one example, the hint is about the communication link/channel. For example, it can imply a need for a new or updated report (e.g., beam or CSI or TDCP). In this case, it is up to NW whether to configure a report for the content (separately).

In one example, the hint is about an RS transmission. For example, it can imply a need for an aperiodic or semi-persistent RS (e.g., CSI-RS, SRS) transmission. The RS transmission can be from the target entity, or from the UE 116.

In one example, the hint is about a selection/switch. For example, it can imply a need for switching from current A to another A, where A is one of current panel(s), TRP(s)/remote radio head(s) (RRH(s)), resource sets, antenna groups, antenna port groups.

In one example, the hint is about beam/CSI parameters. For example, the parameter can be codebook type (e.g., from Type I to Type II or vice versa), or rank restriction (e.g., from high rank to low rank or vice versa).

In one example, the hint is about RS parameters. For example, the parameter can be related to an AP RS trigger, or RS periodicity, or number of SRS ports (panel switch, 1 panel to 2 panel or vice versa) or number of RS resources.

In one example, the hint is about transmission scheme, which can be one of PMI-based, diversity (cyclic delay diversity (CDD), cycling, space frequency block coding (SFBC)), reciprocity (network coding with broadcast (NCB), or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).

In one example, the hint is about transmission parameters, e.g., modulation and coding scheme (MCS), or number of codewords (CWs).

In one embodiment, when there is no pre-notification message/trigger associated with a content, i.e., the report-type is (B), the content can be transmitted using UL resource(s) configured (e.g., configured-grant physical uplink shared channel (PUSCH)), or reserved for the UE 116-initiated report, or via a RACH procedure.

In one embodiment, the report can be associated with (or linked to) a measurement procedure. The timing of this measurement can be aperiodic (AP), or semi-persistent (SP), or periodic (P). The measurement procedure can be based on according to at least one of the following:
In one example, it is based on one or multiple reference signal (RS) resources such as DL RS resource (e.g., NZP CSI-RS or SSB or DL DMRS or tracking RS), UL RS (e.g., SRS or UL DMRS), or SL RS (e.g., SL CSI-RS or SL DMRS).
In one example, it is based on one or multiple reference signal (RS) resource sets (comprising one or multiple RS resources).
In one example, it is based on one or multiple antenna groups.
In one example, it is based on one or multiple antenna port groups.
In one example, it is based on one or multiple TRPs or RRHs.
In one example, it is based on one or multiple antenna panels.

In one example, this association between the report and the measurement procedure is provided/configured (by NW) or/and initiated by the UE 116 (together or separate from the UE 116-initiated report) only when the report needs to include the content, i.e., report-types (B) or (C).

In one embodiment, the report can be an AP report. In one example, the report can be a SP report (i.e., comprising multiple instances of the same report-type, each instance is a self-contained/independent report content).

In one embodiment, as illustrated in FIG. 9C, the content can be transmitted/reported in one-shot (in one part) in an UL slot with the UL resources for reporting the content.
In one example, the trigger/message and the content are transmitted together in the same slot.
In one example, the trigger/message and the content are transmitted in two different UL slots. The offset between the two slots can be fixed, or determined implicitly (without any signaling), or determined based on signaling from the target entity (it is provided via RRC, or MACE CE (MAC CE), or DCI).

In one embodiment, as illustrated in FIG. 9C, the content can be transmitted/reported in two parts. The content can be divided into two (part 1 and part 2).
In one example, part 1 and the trigger/message are multiplexed together (e.g., UCI part 1), and part 2 is separate (e.g., UCI part 2), and they are transmitted in the same slot (e.g., via two-part UCI).
In one example, part 1 and the trigger/message are multiplexed together (e.g., UCI part 1), and part 2 is separate (e.g., UCI part 2), and they are transmitted in the two different slots. The offset between the two slots can be fixed, or determined implicitly (without any signaling), or determined based on signaling from the target entity (it is provided via RRC, or MACE CE (MAC CE), or DCI).
In one example, part 1 and part 2 are multiplexed in UCI part 1 and UCI part 2 of a two-part UCI, which is transmitted in a slot different from the slot for the trigger/message. The offset between the two slots can be fixed, or determined implicitly (without any signaling), or determined based on signaling from the target entity (it is provided via RRC, or MACE CE (MAC CE), or DCI).
In one example, part 1 and part 2 are multiplexed in UCI part 1 and UCI part 2 of a two-part UCI, which is transmitted in a slot that also carried the trigger/message.

In one or more examples described herein, part 2 (of the content) can be absent (not reported). The information on whether it is reported or absent can be reported in part 1 (of the content), e.g., via a UCI parameter such as 1-bit indicator. Or the information on whether it is reported or absent can be determined implicitly based on part 1 (of the content), e.g., after decoding part 1. When part 2 is reported, the UL resource for part 2 can be pre-configured (e.g., with that for part 1), or can be requested via part 1 (or trigger/message).

When there are multiple report-types, the UE 116 can report contents for both report-types.
In one example, one content is included in part 1 and another content is included in part 2.
In one example, subset 1 of both contents are included in part 1 and subset 2 of both contents are included in part 2.

Or, when there are multiple report-types, UE can select one of the report-types, and transmit content for the selected report-type. The selection can be fixed (based on a priority order), or can be based on a configuration, or reported by the UE 116 (e.g., via part 1).

Or, when there are multiple report-types, UE can select n out of N report-types and transmit content for the selected n report-type, where 1≤n≤N. The selection of n report-types can be fixed (based on a priority order), or can be based on a configuration, or reported by the UE 116 (e.g., via part 1).

When the UL resources for reporting part 1 and part 2 of the content(s) of report-type(s) is not sufficient (i.e., the number of information bits e.g., overhead) to report each of the contents is more than the number of information bits allocated for the UL resources), the UE 116 omits (not report) each of part 2, or a portion of the part 2. In one example, this omission procedure is the same as in Rel. 15-17 NR (5.2.3, document and standard [4]). In particular, part 2 of a content can be further partitioned into multiple groups (e.g., 3), and the omission procedures happens according to a priority order of the multiple groups. In one example, part 1 of each report-types are grouped together in one group (G0) which has the highest priority (assuming omission order is low/to high). In one example, the number of groups for a content can be the same for each report-types (e.g., 2 or 3 for each). In one example, the number of groups for a content can be different and depends on the report-types (e.g., one group for one report-type, 2 groups for another report-type, 3 for another report-type). In one example, the number of groups for a content can be configured to the UE 116 (e.g., RRC) or together with signaling for the UL resources. In one example, the number of groups for a content can be reported by the UE 116 (e.g., via part 1).

In one embodiment, as illustrated in FIG. 9B, the content can be transmitted/reported according to at least one of the following examples.
In one example, the content can be transmitted/reported in one-shot (in one part) in an UL slot with the UL resources for reporting the content.
In one example, the content can be transmitted/reported in two parts. The content can be divided into two (part 1 and part 2). In one example, part 1 and part 2 are multiplexed in UCI part 1 and UCI part 2 of a two-part UCI, which is transmitted in one slot.

In example herein, part 2 (of the content) can be absent (not reported). The information on whether it is reported or absent can be reported in part 1 (of the content), e.g., via a UCI parameter such as 1-bit indicator. Or the information on whether it is reported or absent can be determined implicitly based on part 1 (of the content), e.g., after decoding part 1. When part 2 is reported, the UL resource for part 2 can be pre-configured (e.g., with that for part 1), or can be requested via part 1.

When there are multiple report-types, the UE 116 can report contents for both report-types.
In one example, one content is included in part 1 and another content is included in part 2.
In one example, subset 1 of both contents are included in part 1 and subset 2 of both contents are included in part 2.

Or, when there are multiple report-types, UE can select one of the report-types, and transmit content for the selected report-type. The selection can be fixed (based on a priority order), or can be based on a configuration, or reported by the UE 116 (e.g., via part 1).

Or, when there are multiple report-types, UE can select n out of N report-types and transmit content for the selected n report-type, where 1≤n≤N. The selection of n report-types can be fixed (based on a priority order), or can be based on a configuration, or reported by the UE 116 (e.g., via part 1).

When the UL resources for reporting part 1 and part 2 of the content(s) of report-type(s) is not sufficient (i.e., the number of information bits to report each of the contents is more than the number of information bits allocated for the UL resources), the UE 116 omits (not report) each of part 2, or a portion of the part 2. In one example, this omission procedure is the same as in Rel. 15-17 NR (5.2.3, document and standard [4]). In particular, part 2 of a content can be further partitioned into multiple groups (e.g., 3), and the omission procedures happens according to a priority order of the multiple groups. In one example, part 1 of each report-types are grouped together in one group (G0) which has the highest priority (assuming omission order is low/to high). In one example, the number of groups for a content can be the same for each report-types (e.g., 2 or 3 for each). In one example, the number of groups for a content can be different and depends on the report-types (e.g., one group for one report-type, 2 groups for another report-type, 3 for another report-type). In one example, the number of groups for a content can be configured to the UE 116 (e.g., RRC) or together with signaling for the UL resources. In one example, the number of groups for a content can be reported by the UE 116 (e.g., via part 1).

In one embodiment, the number of parts (one part or two parts) for a content can be the same for each report-types (e.g., 1 or 2 for each). In one example, the number of parts for a content can be different and depends on the report-types (e.g., one part for one report-type, 2 parts for another report-type). In one example, the number of parts for a content can be configured to the UE 116 (e.g., RRC) or together with signaling for the UL resources. In one example, the number of parts for a content can be reported by the UE 116 (e.g., via part 1).

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a processor; and
a transceiver operably coupled to the processor, the transceiver configured to transmit information including at least one of (i) a trigger indicating a need for transmitting a report and (ii) content associated with the report,
wherein:
the trigger is related to a channel between the UE and a network entity,
the need is based on at least one performance metric of a communication over the channel, and
the content includes at least one property associated with the channel.

2. The UE of claim 1, wherein:
the processor is further configured to determine the need for transmitting the report, and
the need for transmitting the report is based on an event associated with the at least one performance metric of the communication over the channel.

3. The UE of claim 2, wherein the event corresponds to an event type from at least one of the following event types:
(i) a detection-based event type including at least one of a beam failure, a block error rate (BLER), a decoding failure, a UE panel switch, and an antenna switch,
(ii) a condition-based event-type identified based on comparing a metric with a threshold,
(iii) a beam-related event type including at least one of a beam switch and a beam indication,
(iv) a channel state information CSI-related event type including at least one of a CSI parameter and a CSI-reference signal (RS) resource selection, and
(v) RS-related event type including an aperiodic SRS transmission or an aperiodic CSI-RS reception.

4. The UE of claim 1, wherein the at least one performance metric is based on at least one of:
a failure event associated with the communication,
a throughput,
a time-frequency resource utilization,
a latency associated with the communication,
an overhead associated with the report, and
reliability associated with the communication.

5. The UE of claim 1, wherein the transceiver is further configured to transmit the information in response to an identification of the need for transmitting the report.

6. The UE of claim 1, wherein:
the transceiver is further configured to:
transmit the trigger in a first time slot, and
transmit the report in a second time slot based on the trigger, and
the second time slot is after the first time slot.

7. The UE of claim 1, wherein, based on the at least one property, the report corresponds to a report type from at least one of the following report types:
(i) a beam-related report type including at least one of a beam indicator and a beam metric,
(ii) CSI-related report type including at least one of a rank indicator (RI), a precoding matrix indicator (PMI), a channel quality indicator (CQI), channel state indicator-reference signal (CSI-RS) resource indicator (CRI), a layer indicator (LI), and a time-domain channel property (TDCP),
(iii) a selection of an entity, and
(iv) a switch or update from one entity to another entity,
where:
the entity corresponds to at least one of a selection a beam, an indication of the beam, an antenna port, an antenna port group, and a resource, and
the beam corresponds to a transmission configuration indicator (TCI) state or a source RS.

8. The UE of claim 1, wherein:
the transceiver is further configured to receive at least one reference signal (RS) resource,
the processor is further configured to measure the at least one RS resource for determining the report, and
the channel is at least one of downlink, uplink, and sidelink.

9. A base station (BS) comprising:
a processor; and
a transceiver operably coupled to the processor, the transceiver configured to receive information including at least one of (i) a trigger indicating a need for transmitting a report and (ii) content associated with the report,
wherein:
the trigger is related to a channel between a user equipment (UE) and the BS,
the need is based on at least one performance metric of a communication over the channel, and
the content includes at least one property associated with the channel.

10. The BS of claim 9, wherein the need for transmitting the report is based on an event associated with the at least one performance metric of the communication over the channel.

11. The BS of claim 10, wherein the event corresponds to an event type from at least one of the following event types:
(i) a detection-based event type including at least one of a beam failure, a block error rate (BLER), a decoding failure, a UE panel switch, and an antenna switch,
(ii) a condition-based event-type identified based on comparing a metric with a threshold,
(iii) a beam-related event type including at least one of a beam switch and a beam indication,
(iv) a channel state information CSI-related event type including at least one of a CSI parameter and a CSI-reference signal (RS) resource selection, and
(v) RS-related event type including an aperiodic SRS transmission or an aperiodic CSI-RS reception.

12. The BS of claim 9, wherein the at least one performance metric is based on at least one of:
a failure event associated with the communication,
a throughput,
a time-frequency resource utilization,
a latency associated with the communication,
an overhead associated with the report, and
reliability associated with the communication.

13. The BS of claim 9, wherein the transceiver is further configured to receive the information in response to an identification of the need for transmitting the report.

14. The BS of claim 9, wherein:
the transceiver is further configured to:
receive the trigger in a first time slot, and
receive the report in a second time slot based on the trigger, and
the second time slot is after the first time slot.

15. The BS of claim 9, wherein, based on the at least one property, the report corresponds to a report type from at least one of the following report types:
(i) a beam-related report type including at least one of a beam indicator and a beam metric,
(ii) CSI-related report type including at least one of a rank indicator (RI), a precoding matrix indicator (PMI), a channel quality indicator (CQI), channel state indicator-reference signal (CSI-RS) resource indicator (CRI), a layer indicator (LI), and a time-domain channel property (TDCP),
(iii) a selection of an entity, and
(iv) a switch or update from one entity to another entity,
where:
the entity corresponds to at least one of a selection a beam, an indication of the beam, an antenna port, an antenna port group, and a resource, and
the beam corresponds to a transmission configuration indicator (TCI) state or a source RS.

16. The BS of claim 9, wherein:
the transceiver is further configured to transmit at least one reference signal (RS) resource,
the report is based on the at least one RS resource, and
the channel is at least one of downlink and uplink.

17. A method for operating a user equipment (UE), the method comprising:
transmitting information including at least one of (i) a trigger indicating a need for transmitting a report and (ii) content associated with the report,
wherein:
the trigger is related to a channel between the UE and a network entity,
the need is based on at least one performance metric of a communication over the channel, and
the content includes at least one property associated with the channel.

18. The method of claim 17, further comprising:
determining the need for transmitting the report,
wherein the need for transmitting the report is based on an event associated with the at least one performance metric of the communication over the channel.

19. The method of claim 18, wherein the event corresponds to an event type from at least one of the following event types:
(i) a detection-based event type including at least one of a beam failure, a block error rate (BLER), a decoding failure, a UE panel switch, and an antenna switch,
(ii) a condition-based event-type identified based on comparing a metric with a threshold,
(iii) a beam-related event type including at least one of a beam switch and a beam indication,
(iv) a channel state information CSI-related event type including at least one of a CSI parameter and a CSI-reference signal (RS) resource selection, and
(v) RS-related event type including an aperiodic SRS transmission or an aperiodic CSI-RS reception.

20. The method of claim 17, wherein the at least one performance metric is based on at least one of:
a failure event associated with the communication,
a throughput,
a time-frequency resource utilization,
a latency associated with the communication,
an overhead associated with the report, and
reliability associated with the communication.
